(19) United States
(12) Patent Application Publication
(10) Pub. No.: US 2022/0036876 A1
(43) Pub. Date: Feb. 3, 2022

(54) SPEECH APPARATUS, SERVER, AND CONTROL SYSTEM

(71) Applicant: SHARP KABUSHIKI KAISHA, Sakai City, Osaka (JP)

(72) Inventor: AKIHIRO KANZAKI, Sakai City, Osaka (JP)

(21) Appl. No.: 17/275,913

(22) PCT Filed: Sep. 20, 2019
(86) PCT No.: PCT/JP2019/037109

§ 371 Date: Mar. 12, 2021

(30) Foreign Application Priority Data
Sep. 21, 2018 (JP) 2018-177817

(51) Int. Cl. G10L 15/00; G08B 3/10; G08B 21/18; H04L 29/08

(52) U.S. Cl. CPC G10L 15/00; H04L 67/125; G08B 21/182; G08B 3/10

(57) ABSTRACT

A speech apparatus switches its operation mode between a normal mode and an inhibit mode, determines the degree of urgency of speech information for use in generating speech content, the speech information being obtained from at least one of the speech apparatus, a server, and an external device, and when the degree of urgency is equal to or higher than a predetermined threshold, generates the speech content from the speech information and causes the speech apparatus to speak by audio even if the operation mode is the inhibit mode.

### TECHNICAL FIELD

The present invention relates to speech apparatuses or the like that speak by audio.

### BACKGROUND ART

In a speech apparatus that speaks by audio, a related art configured to inhibit audio speech when audio speech is not desired is known. PTL 1 discloses a speech apparatus whose operation mode shifts, when detecting a predetermined command, from a normal mode in which audio speech is not inhibited to an inhibit mode in which audio speech is inhibited.

### CITATION LIST

### Patent Literature

PTL 1: Japanese Unexamined Patent Application Publication No. 2017-161637

### SUMMARY OF INVENTION

### Technical Problem

However, the invention described in PTL 1 can shift the operation mode of the speech apparatus by the user inputting a predetermined command but cannot cancelling inhibition of audio speech according to the content of the speech. For example, in the case where information to be urgently reported to the user is present, the speech apparatus operating in the inhibit mode cannot output the information by audio.

An aspect of the present invention is made in view of the above problem. Accordingly, it is an object of the invention to provide a convenient speech apparatus or the like that reliably speaks by audio when information to be urgently reported to the user is present.

### Solution to Problem

To solve the above problems, a speech apparatus according to an aspect of the present invention is a speech apparatus that inhibits audio speech when detecting a predetermined command. The speech apparatus is configured to switch an operation mode between a normal mode in which audio speech is not inhibited and an inhibit mode in which audio speech is inhibited, to determine a degree of urgency of speech information for use in generating speech content, the speech information being obtained from at least one of the speech apparatus, a server communicably connected to the speech apparatus, and an external device, and to generate, when the degree of urgency is equal to or higher than a predetermined threshold, the speech content from the speech information and causing the speech apparatus to speak by audio even if the operation mode is the inhibit mode.

A server according to an aspect of the present invention is a server communicably connected to a speech apparatus and causing the speech apparatus to speak by audio. The server is configured to switch an operation mode of the speech apparatus between a normal mode in which audio speech is not inhibited and an inhibit mode in which audio speech is inhibited, to determine a degree of urgency of speech information for use in generating speech content, the speech information being obtained from at least one of the speech apparatus, the server, and an external device, and to generate, when the degree of urgency is equal to or higher than a predetermined threshold, the speech content from the speech information and causing the speech apparatus to speak by audio even if the operation mode is the inhibit mode.

A control system according to an aspect of the present invention is an audio speech control system including a speech apparatus that inhibits audio speech when detecting a predetermined command and a server communicably connected to the speech apparatus. The control system is configured to switch an operation mode of the speech apparatus between a normal mode in which audio speech is not inhibited and an inhibit mode in which audio speech is inhibited, to determine a degree of urgency of speech information for use in generating speech content of the speech apparatus, the speech information being obtained from at least one of the speech apparatus, the server, and an external device, and to generate, when the degree of urgency is equal to or higher than a predetermined threshold, the speech content from the speech information and causing the speech apparatus to speak by audio even if the operation mode of the speech apparatus is the inhibit mode.

A method of control according to an aspect of the present invention is a method for controlling audio speech. The method includes switching an operation mode of the speech apparatus between a normal mode in which audio speech is not inhibited and an inhibit mode in which audio speech is inhibited, determining a degree of urgency of speech information for use in generating speech content of the speech apparatus, the speech information being obtained from at least one of the speech apparatus, a server communicably connected to the speech apparatus, and an external device, and generating, when the degree of urgency is equal to or higher than a predetermined threshold, the speech content from the speech information and causing the speech apparatus to speak by audio even if the operation mode of the speech apparatus is the inhibit mode.

According to an aspect of the present invention, a convenient speech apparatus or the like is provided which reliably speaks by audio when information to be urgently reported to the user is present.

### BRIEF DESCRIPTION OF DRAWINGS

FIG. 1 is a block diagram showing an example of the configuration of the relevant part of a speech control system according to a first embodiment of the present invention.

FIG. 2 is a schematic diagram illustrating, in outline, the speech control system according to the first embodiment of the present invention.

FIG. 3 is a flowchart showing an example of a procedure for performing audio speech according to the degree of urgency of speech information in the speech control system according to the first embodiment of the present invention.

FIG. 4 is a schematic diagram showing a configuration example in which a speech control system according to the first embodiment of the present invention is integrated with a home energy management system (HEMS).

FIG. 5 is a block diagram showing an example of the configuration of the relevant part of a speech control system according to a second embodiment of the present invention.

### DESCRIPTION OF EMBODIMENTS

### First Embodiment

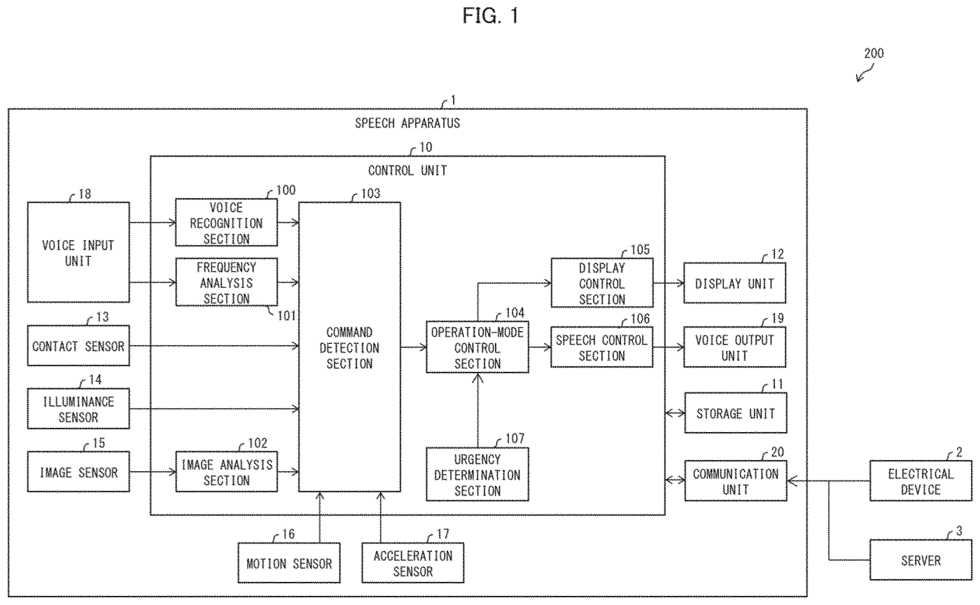

An embodiment of the present invention will be described in detail hereinbelow with reference to FIGS. 1 to 4.

### Speech Control System

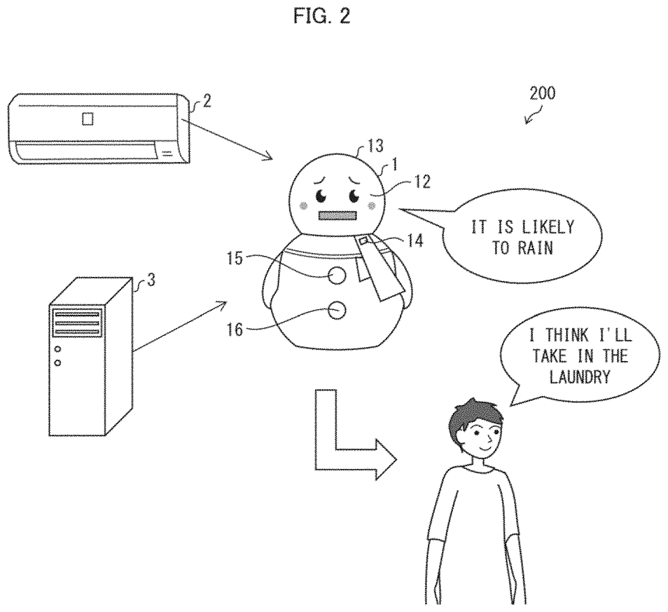

The outline of a speech control system 200 according to this embodiment will be described with reference to FIG. 2. FIG. 2 is a schematic diagram illustrating, in outline, the speech control system 200. In the illustrated example, the speech control system 200 includes a speech apparatus 1, an electrical device 2, and a server 3.

The speech apparatus 1 is an apparatus having a function for speaking by audio. The speech apparatus 1 also has a speech recognition function, by which it can communicate with the user. As illustrated, the speech apparatus 1 includes a display unit 12, a contact sensor 13, an illuminance sensor 14, an image sensor 15, and a motion sensor 16. In the example of FIG. 2, the speech apparatus 1 is a robot but may be a mobile terminal, such as a smartphone.

The display unit 12 displays the face of the speech apparatus 1. In other words, the speech apparatus 1 can express the face of the speech apparatus 1 using the display content on the display unit 12. The contact sensor 13 is a sensor that detects the contact of the user. The illuminance sensor 14 is a sensor that detects the luminance around the speech apparatus 1. The image sensor 15 is a sensor that obtains an image around the speech apparatus 1. The motion sensor 16 is a sensor that detects a person around the speech apparatus 1. The speech apparatus 1 operates according to the detection results of these sensors.

The speech apparatus 1 can operate while switching its operation mode between a normal mode in which audio speech is not inhibited, and an inhibit mode in which audio speech is inhibited, and upon detecting a predetermined command, the speech apparatus 1 can inhibit audio speech. For example, when detecting that the user utters a phrase ordering inhibition of speech, such as “be quiet” as the predetermined command, the speech apparatus 1 can switch the operation mode to the inhibit mode. Likewise, when detecting a command that permits speech, the speech apparatus 1 may switch the operation mode to the normal mode. FIG. 2 illustrates an example in which the speech apparatus 1 is operating in the inhibit mode.

The speech apparatus 1 can obtain speech information from at least one of the various sensors of the speech apparatus 1, the server 3, and the electrical device 2, which is an external device. The speech apparatus 1 can generate speech content using the obtained speech information and can speak the generated speech content by audio. The speech information is information that the speech apparatus 1 uses to generate the content of speech. The speech information includes important information that needs to be urgently reported to the user in case of a significant change from that in the steady state, including physical values, such as detected values from the sensors, and deliver information, such as weather information and fire information. The speech apparatus 1 can generate speech content, for example, by combining the speech information with a template sentence, and can speak by audio.

The electrical device 2 is a device that is outside the speech apparatus 1 and is communicably connected to the speech apparatus 1, for example, a home electrical appliance installed in a house. In the example of FIG. 2, the electrical device 2 is an air-conditioner indoor unit and can obtain the temperature, humidity, and so on inside and outside the room using, for example, a temperature sensor, a humidity sensor, and so on (not shown) and can transmit the obtained information to the speech apparatus 1. The electrical device 2 is not limited home electrical appliances and may be any electrically operated device, such as a sensor. The number of electrical devices 2 may be two or more.

The server 3 is a server that is communicably connected to the speech apparatus 1, for example, a cloud server that provides various kinds of information over a network, such as the Internet. The server 3 can transmit information, such as ambient temperature, humidity, and weather information, to the speech apparatus 1.

When the speech information includes information to be urgently reported to the user, the speech apparatus 1 can generate speech content from the speech information and can speak it by audio even if the speech apparatus 1 is operating in the inhibit mode. In other words, the speech apparatus 1 determines the degree of urgency of the speech information, and if the degree of urgency is equal to or higher than a predetermined threshold, the speech apparatus 1 can speak by audio.

In the example of FIG. 2, the speech apparatus 1 detects that it is likely to rain on the basis of the speech information, such as ambient temperature, humidity, and weather information, obtained from the electrical device 2 and the server 3. The degree of urgency in the speech information indicating that it is likely to rain is set to equal to or higher than a predetermined threshold. At that time, the speech apparatus 1 generates speech content, “it is going to rain”, from speech information with a degree of urgency equal to or higher than the predetermined threshold and speaks by audio. The user determines that it is likely to rain in the surrounding area from the audio speech of the speech apparatus 1 and recognizes that there is a high need to take in the laundry that is being dried outside. Thus, the user can take an appropriate action (in this case, take in the laundry).

Thus, when speech information including information to be urgently reported to the user is present, the speech control system 200 according to this embodiment can generate speech content from the speech information and allows the speech apparatus 1 to speak by audio even if the speech apparatus 1 is operating in the inhibit mode. Thus, the speech control system 200 can be provided which includes the convenient speech apparatus 1 that reliably speaks by audio if information that is to be urgently reported to the user, such as fire information, is present.

The speech information of which the degree of urgency is set to be equal to or higher than a predetermined threshold that allows the speech apparatus 1 to speak by audio even in operation in the inhibit mode is not limited to the above example. For example, the speech apparatus 1 may obtain the detection result from the illuminance sensor 14 or the motion sensor 16, the authentication result of an electronic key, or home power consumption as the speech information and may detect that a person has come back home or gone out of home from its change. Upon detecting that the person has come back or gone out, the speech apparatus 1 may speak by audio even in operation in the inhibit mode because the degree of urgency of the obtained speech information is equal to or higher than the predetermined threshold.

The speech apparatus 1 may also determine the degree of urgency of the speech information using the history of return time and outing time. For example, when the degree of urgency differs by a predetermined value or greater from an average return time or outing time that the accumulated history indicates, the speech apparatus 1 may speak by audio even in operation in the inhibit mode because the degree of urgency of the obtained speech information is equal to or higher than the predetermined threshold. At that time, the target user may be specified on the basis of the voice of the user that the speech apparatus 1 recognized, the authentication result of the electronic key, or whether the speech apparatus 1 is communicating with a mobile terminal, such as a smartphone. For example, when it is determined that the child has not returned home at the average return time, the speech apparatus 1 may speak a speech content worrying about the child. The speech apparatus 1 may also extract only a weekday history on the basis of, for example, calendar information, and calculate average return time and outgoing time on weekdays for use in determination of the degree of urgency.

The speech apparatus 1 may also obtain temperature or humidity information as the speech information, and when the speech apparatus 1 determines that there is a high possibility that it will rain or there is a high risk of health damage, such as heat stroke or heat shock, the speech apparatus 1 may speak by audio even in operation in the inhibit mode. In this case, the speech information for use in determination may be a physical amount, such as temperature or humidity, obtained from the electrical device 2 or the like, or deliver information, such as weather information obtained from the server 3 or the like.

Furthermore, the speech apparatus 1 may set the degree of urgency of information to be urgently reported to the user, such as gas leak information or fire information reported from the electrical device 2 or the like, or earthquake quick report or weather warning (special warning or the like) to be reported from the server 3 or the like to be equal to or higher than a predetermined threshold. In other words, when the speech apparatus 1 obtains information to be urgently reported to the user, the speech apparatus 1 may speak by audio even in operation in the inhibit mode. The information to be urgently reported to the user may include traffic jam information, train delay information, or the like.

### Configuration of Speech Control System

The configuration of the speech control system 200 according to this embodiment will be described with reference to FIG. 1. FIG. 1 is a block diagram showing an example of the configuration of the relevant part of the speech control system 200. The speech control system 200 includes the speech apparatus 1, the electrical device 2, and the server 3. Since the electrical device 2 and the server 3 have been described with reference to FIG. 2, description thereof will not be repeated here.

The speech apparatus 1 includes the control unit 10, the storage unit 11, the display unit 12, the contact sensor 13, the illuminance sensor 14, the image sensor 15, the motion sensor 16, an acceleration sensor 17, a voice input unit 18, a voice output unit 19, and a communication unit 20. Since the display unit 12, the contact sensor 13, the illuminance sensor 14, the image sensor 15, and the motion sensor 16 have been described with reference to FIG. 2, descriptions thereof will not be repeated here.

The storage unit 11 stores various kinds of data dealt in the speech apparatus 1. The storage unit 11 may store a predetermined threshold that an urgency determination section 107, described later, uses in determining the degree of urgency of speech information for each kind of the speech information. The acceleration sensor 17 is a sensor that detects and outputs the acceleration. For example, the movement of the speech apparatus 1 can be detected from the output value of the acceleration sensor 17. The voice input unit 18 receives an audio input from the outside of the speech apparatus 1. The voice output unit 19 outputs voice (speaks by audio) according to the control of the control unit 10. The communication unit 20 is used for the speech apparatus 1 to communicate with the electrical device 2 and the server 3. The communication unit 20 obtains speech information from the electrical device 2 and the server 3 according an instruction from the control unit 10.

The control unit 10 coordinates and provides control of the component of the speech apparatus 1 and includes a voice recognition section 100, a frequency analysis section 101, an image analysis section 102, a command detection section 103, an operation-mode control section 104, a display control section 105, a speech control section 106, and the urgency determination section 107.

The voice recognition section 100 recognizes a voice input that the voice input unit 18 received and outputs the voice recognition result. Specifically, the voice recognition section 100 outputs the words that the user spoke included in the input voice as text data.

The frequency analysis section 101 analyzes the frequency band of the sound (mainly audible sound) received by the voice input unit 18 and outputs the result of analysis. Specifically, the frequency analysis section 101 detects that sound in a predetermined frequency band continues for a predetermined time by the analysis and notifies the command detection section 103 of the detection result. More specifically, the frequency analysis section 101 detects sound in a frequency band equal to or higher than 4,000 Hz and less than 5,000 Hz continuing for a predetermined time. The frequency analysis section 101 also detects sound equal to or lower than 100 Hz continuing for a predetermined time or longer. An example of usage of the frequency analysis section 101 will be described later in a second embodiment.

The image analysis section 102 analyzes the image around the speech apparatus 1, obtained by the image sensor 15, detects the user performing predetermined action, and notifies the command detection section 103 of the detection result. An example of usage of the image analysis section 102 will be described later in a third embodiment.

The command detection section 103 transmits the detection results of the various sensors to the operation-mode control section 104. The detection results may include the command illustrated in FIG. 2. When detecting a predetermined command, the command detection section 103 transmits the detected command to the operation-mode control section 104.

The operation-mode control section 104 switches the operation mode between the normal mode in which audio speech is not inhibited and the inhibit mode in which audio speech is inhibited according to the command detected by the command detection section 103. Specifically, when the operation mode of the speech apparatus 1 is the normal mode, the operation-mode control section 104 outputs various kinds of information using the display control section 105 and the speech control section 106, and when in the inhibit mode, outputs various kinds of information using the display control section 105.

The operation-mode control section 104 can transmit the detection results of the various sensors, received from the command detection section 103, to the urgency determination section 107 as speech information. When receiving a notification that the degree of urgency of the speech information is equal to or higher than a predetermined threshold from the urgency determination section 107, the operation-mode control section 104 can instruct the speech control section 106 to generate speech content from the speech information even if the speech apparatus 1 is operating in the inhibit mode.

The display control section 105 displays an image on the display unit 12. For example, when the operation-mode control section 104 has shifted the operation mode, the display control section 105 displays an image of facial expression according to the operation mode after the shift.

The speech control section 106 controls the speech of the speech apparatus 1. More specifically, the speech control section 106 generates speech content according to speech information, that is, at least one of the detection results of the various sensors, information obtained from the electrical device 2 and the server 3, and the voice recognition result of the voice recognition section 100, and causes the voice output unit 19 to speak by audio. When receiving a detection result that the degree of urgency of the speech information is equal to or higher than a predetermined threshold from the urgency determination section 107, the speech control section 106 can generate speech content and allows the voice output unit 19 to speak the speech content even if the operation mode of the speech apparatus 1 is the inhibit mode.

The urgency determination section 107 determines the degree of urgency on speech information, that is, at least one of the detection results of the various sensors received from the operation-mode control section 104 and information that the control unit 10 obtained from the electrical device 2 and the server 3 via the communication unit 20. The urgency determination section 107 can transmit the determination result to the operation-mode control section 104.

For example, since the detection results of the various sensors that significantly change from those in the steady state are important information (physical amounts) that need to be urgently reported to the user, the urgency determination section 107 determines whether the detection results of the various sensor significantly change from detected values in the steady state. Specifically, when the difference between the detection result and the detected value in the steady state is equal to or greater than a predetermined value, the urgency determination section 107 determines that the detection result significantly changes from that in the steady state. When the detection result significantly changes from that in the steady state, the urgency determination section 107 may determine the degree of urgency of the speech information is equal to or higher than a predetermined threshold. The detected value in the steady state may be a statistic (for example, an average value) based on the past history of the detection results of each of the various sensors.

In the case where the information that the control unit 10 obtained from the electrical device 2 and the server 3 via the communication unit 20 as the speech information is deliver information, such as weather information or fire information, the urgency determination section 107 may determine that the degree of urgency of the speech information is equal to or higher than a predetermined threshold.

### Processing Procedure

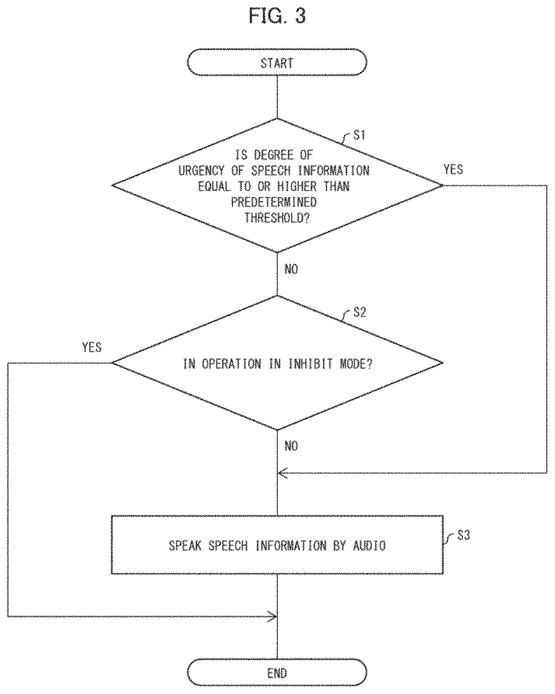

FIG. 3 is a flowchart showing an example of a procedure for determining whether to make an audio speech in the speech apparatus 1 by determining the degree of urgency of speech information in the speech control system 200 according to this embodiment. The operation mode of the speech apparatus 1 at the start of the flowchart may be either of the normal mode and the inhibit mode.

First, the speech apparatus 1 obtains at least one of the detected values from various sensors and information obtained from the electrical device 2 or the server 3 as speech information for constituting the speech content. The urgency determination section 107 determines whether the degree of urgency of the obtained speech information is equal to or higher than a predetermined threshold and transmits the determination result to the operation-mode control section 104 (S1), as described with reference to FIGS. 1 and 2. If it is determined that the degree of urgency is less than the predetermined threshold (S1: NO), the processing goes to S2. In contrast, if it is determined that the degree of urgency is equal o or higher than the predetermined threshold (S1: YES), the processing goes to S3.

In S2, the operation-mode control section 104 determines whether the speech apparatus 1 is operating in the inhibit mode (S2). If it is determined that the speech apparatus 1 is not operating in the inhibit mode (S2: NO), the processing goes to S3. In contrast, if it is determined that the speech apparatus 1 is operating in the inhibit mode (S2: YES), then the operation-mode control section 104 ends a series of processes without instructing the speech control section 106 to perform audio speech.

In S3, the operation-mode control section 104 instructs the speech control section 106 to perform audio speech of the speech information. The speech control section 106 generates speech content from the speech information and causes the speech content voice output unit 19 to speak the speech content by audio (S3).

Thus, the speech apparatus 1 of the speech control system 200 according to this embodiment determines the degree of urgency of speech information constituting speech content. When the degree of urgency is equal to or higher than a predetermined threshold, the speech apparatus 1 can generate speech content from the speech information and can speak the speech content by audio even in operation in the inhibit mode.

### Speech Control of Speech Apparatus in HEMS

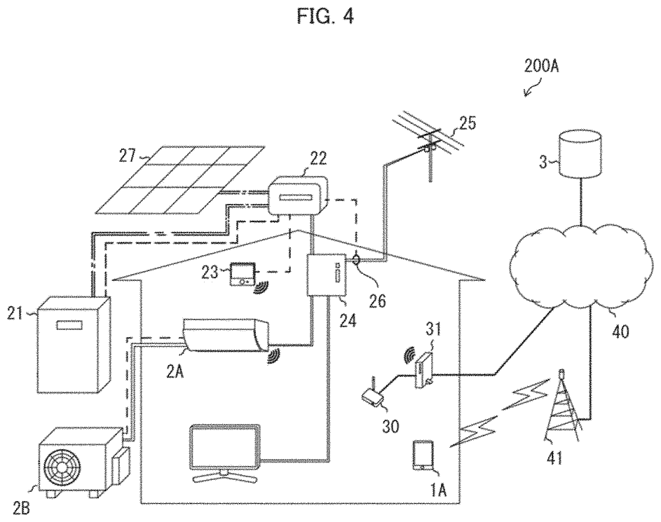

The speech control system according to this embodiment may be configured integrally with a home energy management system (HEMS). A speech control system 200A integrated with the HEMS will be described with reference to FIG. 4. In FIG. 4, a speech apparatus 1A, an air-conditioner indoor unit 2A and an air-conditioner outdoor unit 2B, and a server 3 correspond to the speech apparatus 1, the electrical device 2, and the server 3 in FIG. 1, respectively. In other words, the speech apparatus 1A in FIG. 4 is a mobile terminal, such as a smartphone.

### System Configuration

FIG. 4 is a schematic configuration diagram of the speech control system 200A integrated with the HEMS.

The speech control system 200A illustrated in FIG. 4 includes electrical household appliances, such as the air-conditioner indoor unit 2A, the air-conditioner outdoor unit (electrical device) 10B, and a television set, a power conditioner 22 connected to a battery 21, a power monitor 23, which can obtain information from the power conditioner 22 and display it, an HEMS controller 30 capable of transmitting a remote control signal to the air-conditioner indoor unit 2A, and a router 31 connected to the HEMS controller 30 by wire using Ethernet®.

Of the electrical household appliances, the air-conditioner indoor unit 2A and the air-conditioner outdoor unit 2B are generally referred to as an air conditioner in combination. Accordingly, an air conditioner in the following description includes the air-conditioner indoor unit 2A and the air-conditioner outdoor unit 2B. The air-conditioner indoor unit 2A has a function for communication using a wireless LAN and can communicate with the HEMS controller 30 via the router 31 having the function of wireless LAN.

The power conditioner 22 is connected to a solar cell (solar cell panel) 27 and the battery 21, and has, for example, a function for storing direct-current power generated by the solar cell 27 in the battery 21, a function for converting the direct-current power generated by the solar cell 27 and the power stored in the battery 21 to alternating-current power and supplying the alternating-current power to a load (electrical device), a function for reversing the power to a system power grid 25, and a function for converting alternating-current power supplied from the system power grid 25 to direct-current power and storing the direct-current power in the battery 21. The power conditioner 22 obtains information on the direction and the magnitude of electric current by monitoring the main power of the house in which the speech control system 200A of this embodiment is disposed using a sensor 26. Thus, the power conditioner 22 determines whether power is purchased through the system power grid 25 (power purchase status) or power is reversed to the system power grid 25 (power sale status). Furthermore, the power conditioner 22 has a function for measuring the power generated by the solar cell 27 and a function for obtaining information on the amount of power stored in the battery 21 from the battery 21.

The power monitor 23 has, for example, a function for communicating with the display unit, a user operation receiving unit, and the power conditioner 22. This allows the user to check the information obtained by the power conditioner 22 using the power monitor 23. Furthermore, the power monitor 23 can receive an operation from the user, so that the operation of the power conditioner 22 and so on can be controlled. The power monitor 23 also has a communication function via a wireless LAN, so that it can cooperate with an external device on the basis of a wireless control instruction conforming to ECHONETLite® or the like.

The HEMS controller 30 is a control unit that transmits a control instruction conforming to ECHONETLite to a device to be controlled (in this embodiment, the air-conditioner indoor unit 2A). The control instruction may be transmitted on the basis of the determination of the HEMS controller 30. Alternatively, the HEMS controller 30 may relay a control instruction transmitted from the server 3. In this case, the control instruction from the HEMS controller 30 is transmitted to a target device via the router 31.

The HEMS controller 30 also has a function for measuring the power consumption of each electrical household appliance using a power measuring device (not illustrated) provided for each electrical household appliance and transmitting information on the measured consumed power to the server 3. This allows the user to check the information on the power of each electrical household appliance, stored in the server 3, using the speech apparatus 1A. The HEMS controller 30 can cooperate with the power monitor 23 using a control instruction conforming to ECHONETLite.

The router 31 is a general router and has a function for connecting to the Internet 40. The router 31 has an IEEE802.11 standard wireless local area network (LAN) and communicates with the air-conditioner indoor unit 2A using the wireless LAN. The router 31 is connected to the HEMS controller 30 by wire using Ethernet®.

In addition to the functions described with reference to FIGS. 1 and 2, the speech apparatus 1A also has a function of a HEMS component. In other words, when the degree of urgency of speech information obtained from an electrical device connected to an HEMS is equal to or higher than a predetermined threshold, the speech apparatus 1A can generate speech content from the speech information and perform audio speech even in operation in the inhibit mode. The speech apparatus 1A can access the server 3 to view information on the power consumption of each electrical household appliance in the speech control system 200A and its operating state and to register control instructions on each electrical household appliance.

Since the communication between the speech apparatus 1A and the server 3 is performed via a public telephone network 41 and the Internet 40, the user can perform control from remote location. In the case where the user is at home, the communication may be performed via the router 31 using a wireless LAN.

In addition to the functions described with reference to FIGS. 1 and 2, the server 3 includes an interface for communicating with the HEMS controller 30, and when a control instruction is given to a control target electrical household appliance from the speech apparatus 1A, transmits the instruction to the HEMS controller 30. The server 3 also has a function for receiving and storing information on generated power, sold power, purchased power, power consumption of each electrical device, and integrated power transmitted from the HEMS controller 30. The server 3 also includes an interface for communicating with the speech apparatus 1A, and when receiving a request from the speech apparatus 1A, provides the above information to the speech apparatus 1A.

Although this embodiment implements the above functions with a single server 3, the individual functions may be implemented by different servers. For example, it will be appreciated that a server that transmits deliver information and so on to the speech apparatus 1A and a server having functions related to the HEMS controller 30, such as a function for remotely controlling electrical household appliances and a function for receiving information on the transmitted electric power and integral power consumption are different servers, and the information are exchanged between the servers.

### Second Embodiment

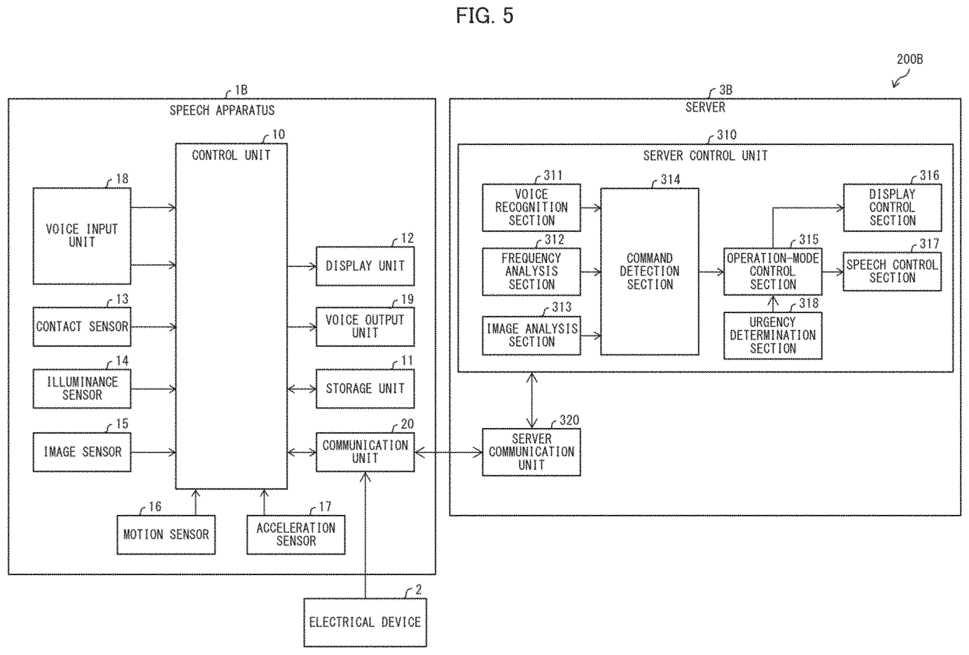

A second embodiment of the present invention will be described hereinbelow with reference to FIG. 5. Components having the same functions as the components described in the above embodiment are given the same reference signs, and descriptions thereof will not be repeated.

### Configuration of Speech Control System

A speech control system 200B according to this embodiment will be described with reference to FIG. 5. FIG. 5 is a block diagram showing an example of the configuration of the relevant part of the speech control system 200B. The speech control system 200B includes a speech apparatus 1B, an electrical device 2, and a server 3B.

The configuration of the speech control system 200B is basically the same as that of the speech control system 200 according to the first embodiment but partly differs. The speech control system 200B performs the various processes that the speech apparatus 1 of the first embodiment performs using the server 3B.

The speech apparatus 1B is configured to perform the various processes performed by the speech apparatus 1 of the first embodiment using the server 3B. Specifically, the speech apparatus 1B transmits the voice received by the voice input unit 18, the detection results of the various sensors, and the information received from the electrical device 2 to the server 3B via the communication unit 20. The speech apparatus 1B performs audio speech using the voice output unit 19 and switches the operation mode according to the various kinds of data received from the server 3B via the communication unit 20.

The server 3B can perform various processes that the speech apparatus 1 performs in the first embodiment. In the illustrated example, the server 3B includes a server control unit 310 and a server communication unit 320. The server control unit 310 includes a voice recognition section 311, a frequency analysis section 312, an image analysis section 313, a command detection section 314, an operation-mode control section 315, a display control section 316, a speech control section 317, and an urgency determination section 318.

The server control unit 310 transmits and receives various kinds of data to and from the speech apparatus 1B via the server communication unit 320. The voice recognition section 311, the frequency analysis section 312, the image analysis section 313, the command detection section 314, the operation-mode control section 315, the display control section 316, the speech control section 317, and the urgency determination section 318 correspond to the voice recognition section 100, the frequency analysis section 101, the image analysis section 102, the command detection section 103, the operation-mode control section 104, the display control section 105, the speech control section 106, and the urgency determination section 107 in the first embodiment, respectively.

Specifically, when the data received from the speech apparatus 1B contains a command for switching the operation mode of the speech apparatus 1B to the inhibit mode, the server 3B can detect the command using the command detection section 314. At that time, the operation-mode control section 315 can switch the operation mode of the speech apparatus 1B to the inhibit mode by not giving an instruction to generate speech content to the speech control section 317.

When the speech information is at least one of the detection results of various sensors of the speech apparatus 1B, information that the speech apparatus 1B has received from the electrical device 2, and information that the server 3B has, the urgency determination section 318 of the server 3B can determine the degree of urgency of the speech information. When the degree of urgency of the speech information is equal to or higher than a predetermined threshold, the operation-mode control section 315 instructs the speech control section 317 to generate speech content from the speech information even while operating the speech apparatus 1B in the inhibit mode. The speech content generated by the speech control section 317 is transmitted to the speech apparatus 1B, and the speech apparatus 1B speaks the received speech content by audio using the voice output unit 19.

Thus, the speech control system 200B according to this embodiment allows the speech apparatus 1B to speak by audio reliably when information to be urgently reported to the user is present by executing various processes using the server 3B, similarly to the speech control system 200 according to the first embodiment.

### Modification

In the above embodiments, the tone, the volume, and so on when the speech apparatuses 1, 1A, and 1B perform audio speech may be changed according to the degree of urgency of speech information. For example, the speech apparatuses 1, 1A, and 1B may speak at a volume increased according to the degree of urgency of the speech information. In the case where the speech information is information indicating a high degree of danger, such as fire information, the speech apparatuses 1, 1A, and 1B may speak by audio at a tone with a sense of urgency.

Speech information of which the degree of urgency is equal to or higher than a predetermined threshold may be reported to the user using a device other than the speech apparatuses 1, 1A, and 1B. For example, when the electrical device 2 includes a display or a speaker, the speech apparatuses 1, 1A, and 1B may generate speech content from the speech information and speak by audio and may output the speech information by video or audio using the electrical device 2.

### Implementation Examples Using Software

The control blocks (in particular, the operation-mode control section 104 and the urgency determination section 107) of the speech apparatus 1 may be implemented by a logic circuit (hardware) formed in an integrated circuit (an IC chip) or the like or by software.

In the latter case, the speech apparatus 1 includes a computer that executes instructions of a program, which is software for implementing various functions. The computer includes, for example, at least one processor (a control unit) and at least one computer-readable recording medium storing the program. The object of the present invention is achieved by the processor in the computer reading the program from the recording medium and executes the program. An example of the processor is a central processing unit (CPU). Examples of the recording medium include “a non-transitory tangible medium”, such as a read-only memory (ROM), a tape, a disk, a card, a semiconductor memory, and a programmable logic circuit. The computer may further include a random-access memory (RAM) in which the program is expanded. The program may be supplied to the computer via any transmission medium (for example, a communication network or a broadcast wave) capable of transmitting the program. In one embodiment of the present disclosure, the program may be implemented in the form of a data signal embodied by electronic transmission and embedded in a carrier wave.

### SUMMARY

A speech apparatus according to a first aspect of the present invention is a speech apparatus that inhibits audio speech when detecting a predetermined command. The speech apparatus is configured to switch an operation mode between a normal mode in which audio speech is not inhibited and an inhibit mode in which audio speech is inhibited, to determine a degree of urgency of speech information for use in generating speech content, the speech information being obtained from at least one of the speech apparatus, a server communicably connected to the speech apparatus, and an external device, and to generate, when the degree of urgency is equal to or higher than a predetermined threshold, the speech content from the speech information and causing the speech apparatus to speak by audio even if the operation mode is the inhibit mode.

The above configuration allows the speech apparatus, when speech information of which the degree of urgency is equal to or higher than a predetermined threshold is present, to generate speech content from the speech information and to speak by audio even in operation in the inhibit mode. This provides the advantageous effect of providing a convenient speech apparatus that assuredly speaks by audio when information to be urgently reported to the user, such as fire information, is present.

A speech apparatus according to a second aspect of the present invention may be configured such that, in the first aspect, the speech information may include a physical amount, wherein, when the physical amount has significantly changed from a steady state, the speech apparatus determines that the degree of urgency is equal to or higher than the predetermined threshold. The above configuration allows the speech apparatus, when the physical amount included in the speech information has changed from the steady state and needs to be urgently reported to the user, to generate speech content from the speech information and speak by audio even in operation in the inhibit mode.

A speech apparatus according to a third aspect of the present invention may be configured, in the second aspect, to determine that the degree of urgency is equal to or higher than the predetermined threshold when a difference between the physical amount and a statistic based on past history on the physical amount is equal to or greater than a predetermined value. The above configuration allows the speech apparatus, when the physical amount included in the speech information differs significantly from the statistic based on the past history on the physical amount by a predetermined value or greater, to generate speech content from the speech information and to speak by audio even in operation in the inhibit mode.

A speech apparatus according to a fourth aspect of the present invention may be configured such that, in the second or third aspect, the physical amount is a power consumption. The above configuration allows the speech apparatus, when the power consumption has significantly changed from the steady state, to generate speech content from the speech information and to speak by audio even in operation in the inhibit mode.

A server according to a fifth aspect of the present invention is a server communicably connected to a speech apparatus and causing the speech apparatus to speak by audio. The server is configured to switch an operation mode of the speech apparatus between a normal mode in which audio speech is not inhibited and an inhibit mode in which audio speech is inhibited, to determine a degree of urgency of speech information for use in generating speech content, the speech information being obtained from at least one of the speech apparatus, the server, and an external device, and to generate, when the degree of urgency is equal to or higher than a predetermined threshold, the speech content from the speech information and causing the speech apparatus to speak by audio even if the operation mode is the inhibit mode. The above configuration provides operational advantages similar to those of the first aspect.

A control system according to a sixth aspect of the present invention is an audio speech control system including a speech apparatus that inhibits audio speech when detecting a predetermined command and a server communicably connected to the speech apparatus. The control system is configured to switch an operation mode of the speech apparatus between a normal mode in which audio speech is not inhibited and an inhibit mode in which audio speech is inhibited, to determine a degree of urgency of speech information for use in generating speech content of the speech apparatus, the speech information being obtained from at least one of the speech apparatus, the server, and an external device, and to generate, when the degree of urgency is equal to or higher than a predetermined threshold, the speech content from the speech information and causing the speech apparatus to speak by audio even if the operation mode of the speech apparatus is the inhibit mode. The above configuration provides operational advantages similar to those of the first aspect.

A method of control according to a seventh aspect of the present invention is a method for controlling audio speech. The method includes switching an operation mode of the speech apparatus between a normal mode in which audio speech is not inhibited and an inhibit mode in which audio speech is inhibited, determining a degree of urgency of speech information for use in generating speech content of the speech apparatus, the speech information being obtained from at least one of the speech apparatus, a server communicably connected to the speech apparatus, and an external device, and generating, when the degree of urgency is equal to or higher than a predetermined threshold, the speech content from the speech information and causing the speech apparatus to speak by audio even if the operation mode of the speech apparatus is the inhibit mode. The above configuration provides operational advantages similar to those of the first aspect.

The speech apparatus 1 according to the aspects of the present invention may be implemented by a computer. In this case, a control program for the speech apparatus 1 causing the speech apparatus 1 to be implemented by the computer by operating the computer as the components (software elements) of the speech apparatus 1 and a computer-readable recording medium storing the program are also within the scope of the present invention.

It is to be understood that the present invention is not limited to the above embodiments and various modifications may be made within the scope of the appended claims and that embodiments obtained by combining the technical means disclosed in the different embodiments are also included in the technical scope of the present invention. It is also to be understood that new technical features can be formed by combining the technical means disclosed in the above embodiments.

### REFERENCE SIGNS LIST

200, 200A, 200B SPEECH CONTROL SYSTEM

1, 1A, 1B SPEECH APPARATUS

10 CONTROL UNIT

104 OPERATION-MODE CONTROL SECTION

106 SPEECH CONTROL SECTION

107 URGENCY DETERMINATION SECTION

11 STORAGE UNIT

2 ELECTRICAL DEVICE (EXTERNAL DEVICE)

3, 3B SERVER

310 SERVER CONTROL UNIT

315 OPERATION-MODE CONTROL SECTION

317 SPEECH CONTROL SECTION

318 URGENCY DETERMINATION SECTION

1. A speech apparatus that inhibits audio speech when detecting a predetermined command, the speech apparatus characterized by:
switching an operation mode between a normal mode in which audio speech is not inhibited and an inhibit mode in which audio speech is inhibited;
determining a degree of urgency of speech information for use in generating speech content, the speech information being obtained from at least one of the speech apparatus, a server communicably connected to the speech apparatus, and an external device; and
generating, when the degree of urgency is equal to or higher than a predetermined threshold, the speech content from the speech information and causing the speech apparatus to speak by audio even if the operation mode is the inhibit mode.

2. The speech apparatus according to claim 1, wherein the speech information includes a physical amount, wherein, when the physical amount has significantly changed from a steady state, the speech apparatus determines that the degree of urgency is equal to or higher than the predetermined threshold.

3. The speech apparatus according to claim 2, characterized by determining that the degree of urgency is equal to or higher than the predetermined threshold when a difference between the physical amount and a statistic based on past history on the physical amount is equal to or greater than a predetermined value.

4. The speech apparatus according to claim 2, wherein the physical amount is a power consumption.

5. A server communicably connected to a speech apparatus and causing the speech apparatus to speak by audio, the server characterized by:
switching an operation mode of the speech apparatus between a normal mode in which audio speech is not inhibited and an inhibit mode in which audio speech is inhibited;
determining a degree of urgency of speech information for use in generating speech content, the speech information being obtained from at least one of the speech apparatus, the server, and an external device; and
generating, when the degree of urgency is equal to or higher than a predetermined threshold, the speech content from the speech information and causing the speech apparatus to speak by audio even if the operation mode is the inhibit mode.

6. An audio speech control system characterized by comprising:
a speech apparatus that inhibits audio speech when detecting a predetermined command; and
a server communicably connected to the speech apparatus, the control system characterized by:
switching an operation mode of the speech apparatus between a normal mode in which audio speech is not inhibited and an inhibit mode in which audio speech is inhibited;
determining a degree of urgency of speech information for use in generating speech content of the speech apparatus, the speech information being obtained from at least one of the speech apparatus, the server, and an external device; and
generating, when the degree of urgency is equal to or higher than a predetermined threshold, the speech content from the speech information and causing the speech apparatus to speak by audio even if the operation mode of the speech apparatus is the inhibit mode.

7. (canceled)

8. (canceled)
